(19) United States
(12) Patent Application Publication
(10) Pub. No.: US 2011/0108667 A1
(43) Pub. Date: May 12, 2011

(54) Thermoplastic Composite Window Panel for Aircraft Applications

(76) Inventors: Hans-Peter KELLER, Suhr (CH); Reto BAMERT-FALLEGGER, Hochdorf (CH); Peter James SAJIC, Broadstone, Dorset (GB)

(21) Appl. No.: 12/617,416

(22) Filed: Nov. 12, 2009

(51) Int. Cl. B64C 1/00; B29C 69/00; B29C 51/00

(52) U.S. Cl. 244/119; 264/241

(57) ABSTRACT

An aircraft trim panel structure includes a thermoplastic resinated quadraxial fiberglass lay-up prepreg first open structure skin layer having at least a 28% open area. A thermoplastic resinated quadraxial fiberglass lay-up prepreg second open structure skin layer has at least a 28% open area. An open structure core layer having at least a 28% open area is sandwiched between the first open structure skin layer and the second open structure skin layer. The first open structure skin layer, the second open structure skin layer and the open structure core layer are formed into a three dimensional shape corresponding to the aircraft trim panel.

### BACKGROUND OF THE INVENTION

1. Field of the Invention

The present invention relates to aircraft trim panels and, more specifically, to thermoformed aircraft trim panel.

2. Description of the Prior Art

An aircraft trim panel is a panel that separates the outer skin of an aircraft from the interior of the cabin. Typically, an aircraft trim panel is a structure mounted to a framework that forms an open space between the trim panel and the outer skin. Most aircraft are built about a structural framework. The outer skin is applied to the framework and thermal insulation is placed between the skin and the cabin interior. A trim panel, which often has a decorative interior surface, is used to cover the insulation and the framework.

Existing trim panels are typically constructed of a thin layer of a rigid material that has an impact resistance that meets the manufacturer's standards. One side of the rigid material layer may include an aesthetic surface and a layer of sound absorptive material may be applied to the other side. The panel is then attached to the structural framework with anti-vibration mounts.

Several different trim panels have been designed in attempt to reduce noise radiation from outside the aircraft. One type of panel includes a honeycomb core layer made of a rigid material to provide the necessary structural strength and a layer of a damping foam material outside of the honeycomb core layer. An aesthetic decor layer material is placed on the cabin side of the honeycomb core.

Certain types of trim panels of a deep three dimensional topography. For example, window units typically include an indentation of several centimeters and include several angles for aesthetic purposes. Some such panels are manufactured using a vacuum forming technology where a piece of sheet plastic is heated to a temperature that causes the sheet to soften. Once soft, the plastic sheet is place on a form that has the shape of the final trim panel and then a vacuum is applied to the plastic sheet so that it is drawn to the form. The sheet is then cooled so that it maintains the shape of the form. However, such trim panels, because they are made from an impervious sheet, tend to transmit external noise in a manner similar to the way audio speakers radiate sound.

Other types of sound attenuating trim panels have been attempted. However, such trim panels involve time consuming and expensive manufacturing steps.

Therefore, there is a need for an aircraft trim panel that can be manufactured quickly and that attenuates noise without radiating it into the cabin.

### SUMMARY OF THE INVENTION

The disadvantages of the prior art are overcome by the present invention which, in one aspect, is a method of making a trim panel for an aircraft, in which an open structure core layer is sandwiched between a first open structure skin layer and a second open structure skin layer thereby forming a bundle having a top surface, an opposite bottom surface and an outward periphery. At least one of the open structure core layer, the first open structure skin layer and the second open structure skin layer includes a material that changes ductility as a result of heat being applied thereto. A first impervious diaphragm is applied to the top surface and a second impervious diaphragm is applied to the bottom surface. The first impervious diaphragm, the bundle and the second impervious diaphragm are clamped about the periphery, thereby creating an airtight seal about the bundle. The bundle is subjected to a vacuum and is heated to a first predetermined temperature. The bundle is placed between a male half of a mold and a female half of a mold. The mold is shaped so as to produce a cast having a shape corresponding to an aircraft trim panel. A force that is sufficient to cause the bundle to take the shape of the cast is applied to the mold. The bundle is cooled to a second predetermined temperature after the force has been applied to the bundle for a predetermined amount of time, the second predetermined temperature being cool enough to cause the bundle to maintain the shape of the aircraft trim panel. The male half of the mold is separated from the female half of the mold once the bundle has reached the second predetermined temperature and the trim panel is removed from the mold.

In another aspect, the invention is an aircraft trim panel that includes a first open structure skin layer, a second open structure skin layer and an open structure core layer sandwiched therebetween. The first open structure skin layer, the second open structure skin layer and the open structure core layer are formed into a three dimensional shape corresponding to the aircraft trim panel.

In yet another aspect, the invention is an aircraft trim panel structure that includes a thermoplastic resinated quadraxial fiberglass lay-up prepreg first open structure skin layer having at least a 28% open area. A thermoplastic resinated quadraxial fiberglass lay-up prepreg second open structure skin layer has at least a 28% open area. An open structure core layer having at least a 28% open area is sandwiched between the first open structure skin layer and the second open structure skin layer. The first open structure skin layer, the second open structure skin layer and the open structure core layer are formed into a three dimensional shape corresponding to the aircraft trim panel.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIGS. 1A-1F are a series of schematic diagrams demonstrating a method of thermoforming an aircraft trim panel.

FIG. 2A is a perspective view of a male half of a mold that can be used to thermoform an aircraft trim panel.

FIG. 2B is a cross-sectional view of the male half of a mold shown in FIG. 2A, taken along line 2B-2B.

FIG. 3A is a perspective view of a female half of a mold that can be used to thermoform an aircraft trim panel.

FIG. 3B is a cross-sectional view of the female half of a mold shown in FIG. 3A, taken along line 3B-3B.

FIG. 4 is a photograph of a bundle including an open structure core layer sandwiched between a first open structure skin layer and a second open structure skin layer.

FIG. 5 is a photograph of an aircraft trim panel formed from a bundle of the type shown in FIG. 4.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Aircraft trim panels are disclosed in U.S. Patent Application Publication No. US 2009/0173571 A1, the entirety of which is hereby incorporated by reference.

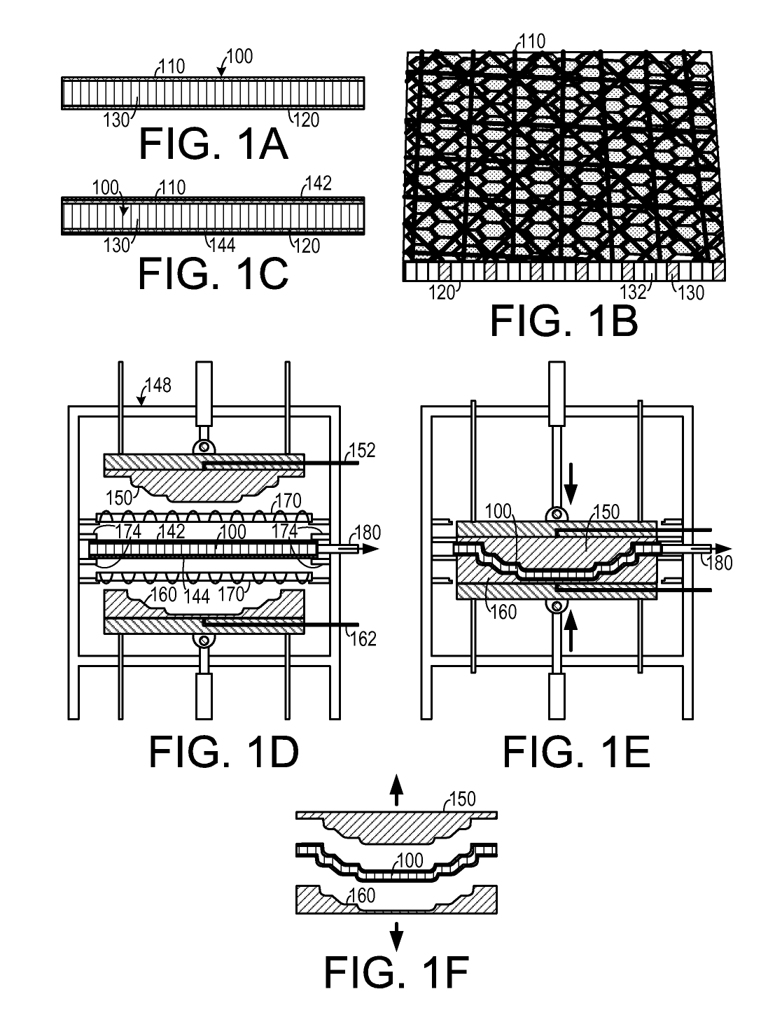

As shown in FIG. 1A-1B, a trim panel can be formed from a bundle 100 of a hybrid material that includes an open structure core layer 130 sandwiched between a first open structure skin layer 110 and a second open structure skin layer 120. The open structure core layer 130 could include an open cell honeycomb material, an open cell tubular sheet material (such as a High Performance Tubus PEI Core material available from Tubus Bauer GmbH, Stöckackerstr. 1, 79713 Bad Säckingen, Germany) or a perforated thermoforming foam material. The open structure core layer 130 typically will have at least a 28% open area. Typically, the core layer 130 would include a thermoplastic, such as a polyetherimide or a polycarbonate. However, in one example, it can include Nomex®. While most embodiments of the open structure core layer 130 include a thermoplastic material, a thermosetting material could be used; however, such a material would require a longer setting time that a thermoplastic material.

The first open structure skin layer 110 and the second open structure skin layer 120 could be made from a quadraxial fiberglass lay-up prepreg material with a resin matrix or a reinforced thermoplastic skin material. A quadraxial fiberglass lay-up prepreg material could include fiberglass strand bundles impregnated with a thermoplastic resin and laid out along several different axes. In one embodiment, the strand bundles are laid out in a first direction, a second direction that is +45° from the first direction, a third direction that is −45° from the first direction and a third direction that is 90° from the first direction. Like the open structure core layer 130, the first open structure skin layer 110 and the second open structure skin layer 120 will typically have at least a 28% open area. The open are allows air to flow therethrough, thereby reducing the radiation of noise.

As shown in FIG. 1C, a first impervious rubber diaphragm 142 is applied to the first open structure skin layer 110 (a mold release film may be applied between the two to facilitate separation of the diaphragm 142 from the skin layer 110 after the molding process has completed) and a second impervious rubber diaphragm 144 is applied to the second open structure skin layer 120 (again, a mold release film can be applied therebetween). Additional binder layers (slit films or non-woven's felts) may be used for increased adherence between core layer and the surface layers, all of which may be stapled to form the bundle 100.

As shown in FIGS. 1D-1E, the combination 140 of the bundle 100 and with the diaphragms 142 and 144 is clamped about its periphery using a clamp frame 174. A vacuum port 180 allows access into the bundle 100. The bundle is heated with a pair of radiant heating elements 170 until the material in the bundle 100 is soft enough for forming in a mold. The mold includes a male portion 150 having the shape of the desired trim panel and a complimentary-shaped female portion 160 that are placed in a 3-D deep drawing thermoforming machine 148, such as a Geiss T8 Thermoforming Machine available from Geiss AG, Industriestraβe 2, D-96145 Seβlach, Germany. The thermoforming machine 148 includes a first heating and cooling access element 152 used to apply heat to the male portion 150 and a second heating and cooling access element 162 that is used to apply heat to the female portion 160. Using thermoplastic core and skin layers with a 3-D deep-draw thermoforming machine 148 discussed above allows such complex parts to be produced in a cycle time of less than 5 minutes.

Atmospheric pressure compresses the bundled material and holds it together during the thermoforming process as a result of the vacuum applied to the bundle 100 via the vacuum access port 180. During the entire thermoforming (molding and binding) process, the clamping force on the bundle can be controlled by adjusting the force of the clamping device 174 or the level of vacuum applied thereto.

The diaphragm layers 142 and 144 convert the heat from the radiant heating elements 170 into a radiant panel heating device. The diaphragm layers 142 and 144 store heat for the interval between the time when the heating elements 170 are moved away and before the deep-drawing process begins. Thus, optimal temperature control during the entire process is maintained.

The entire bundle (material bundle 100 enclose in two outer rubber diaphragm layers 142 and 144) is heated using the radiant heating elements 174 of the thermoforming machine 148 in a controlled process. The exact temperature profile is continuously monitored and controlled with thermocouples and or contact-free pyrometer measurements during the entire molding and bonding process. The thermal energy is transmitted through the rubber membrane diaphragm layers 142 and 144 until the required temperature is achieved for the molding process and for the process of bonding the outer skin layers 110 and 120 to the core layer 130. During the deep-draw process the individual layers can glide against each other to avoid internal friction or shear forces until the full 3-D molding process is finished. Finally the bonding process of the outer layers 110 and 120 with the core layer 130 takes place under a defined molding pressure applied by the temperature controlled upper and lower molding tool.

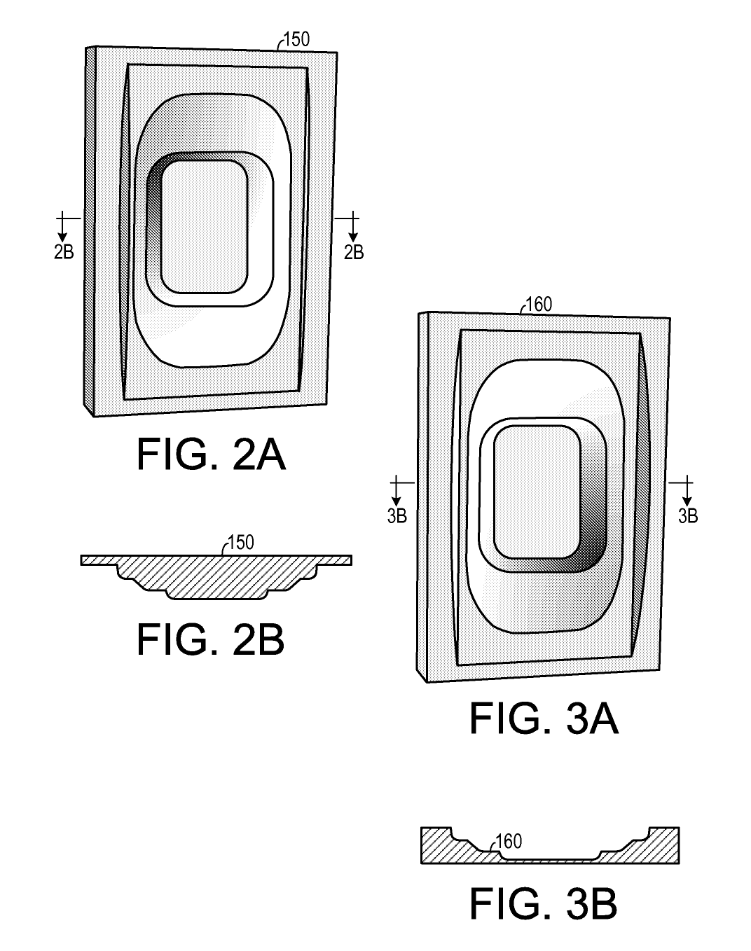

Once the bundle 100 reaches a temperature to be suitably soft for thermoforming, the heating elements 170 are moved out of the way of the male portion 150 and the female portion 160 and the thermoforming machine presses the male portion 150 and the female portion 160 of the mold together while a vacuum is applied to the bundle 100. Once formed into a cast having the shape of a trim panel, the bundle 100 is allowed to cool and, once it cools to the point in which it will maintain its shape, the male portion 150 is separated from the female portion 160 of the mold and the bundle 100, in the form of the trim panel, is removed. A perspective view and a cross sectional view of the male portion 150 of the mold is shown in FIGS. 2A and 2B, while a perspective view and a cross sectional view of the female portion 160 of the mold is shown in FIGS. 3A and 3B.

The entire bundle 110 can be prepared outside the molding machine 148. Such a prepared material package can even be pre-heated before applying it into the thermoforming/molding press. After the molding and bonding process has completed, the entire bundle can be taken out of the machine and further cooled down in a separate cooling station to reach the mold release temperature before de-molding.

The 3-D deep-drawn, non-structural, self supporting, light-weight substrate materials with an entire open structure of >28% of the total surface area may be used to manufacture such panels as acoustic trim panels, Dado-panels, ceiling panels, class separator panels and non-structural bulkheads. These panels may be used in aircraft, boats, railway cars and coaches with outstanding acoustic properties.

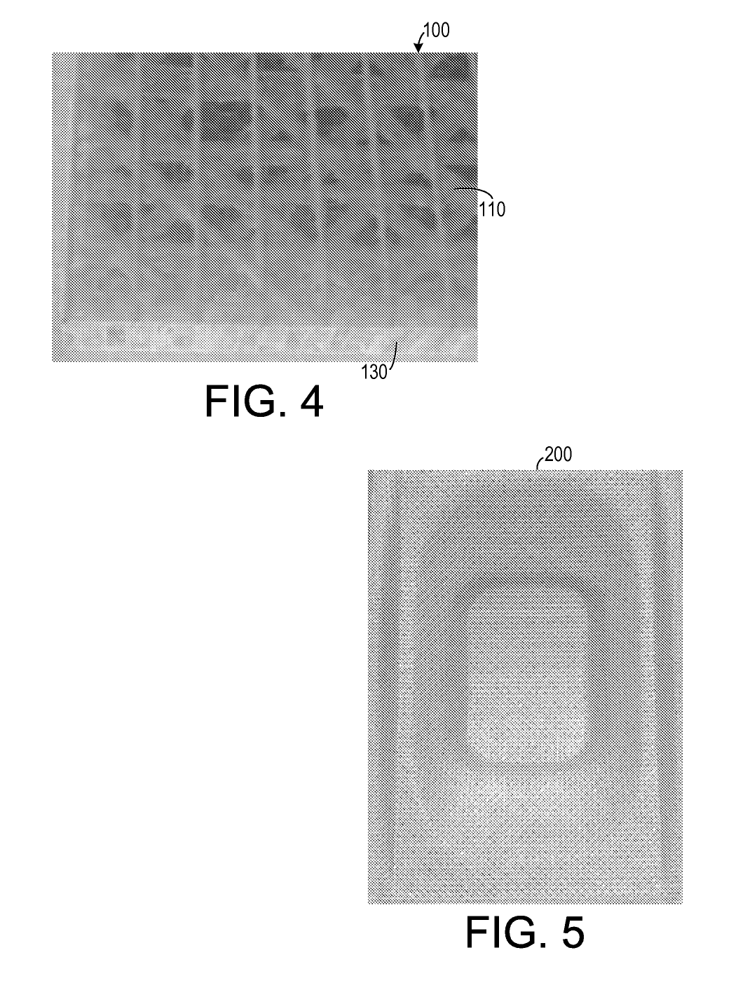

A photograph of a bundle 100 of a hybrid material that includes an open structure honeycomb core layer sandwiched between a first open structure skin layer 110 and a second open structure skin layer is shown in FIG. 4 and a photograph of a resulting trim panel blank 200 is shown in FIG. 5. The blank 200 will be trimmed to its final size and the window hole will be cut out using conventional plastic cutting tools.

An advantage of this embodiment is that the open surface materials (e.g., quadraxial fiber glass prepreg with thermosetting or thermoplastic matrix and/or perforated thermoplastic skin material) have a low resistance to deep-drawing (i.e., they present a low tensile strength) under heat compared to continuously fiber reinforced skin materials. Use of the double diaphragm thermoforming method allows the materials to pre-stretch before the actual deep-drawing process. The use of clamping, a lower tensile strength and pre-forming can eliminate puckering and wrinkling in the finished trim panel.

It is possible to produce trim panels from thermosetting, hybrid and/or thermoplastic sandwich materials with open core structures like thermosetting honeycomb cores, thermoplastic tubular cores, perforated foam cores or rigid foams with skeleton type large open cell structures, etc, covered on both sides with open surface materials, whereas the open area is equal or greater than 28% of the total surface area (e.g. quadraxial fiber glass layup's non cramped fibers (NCF) prepreg with a thermosetting or thermoplastic resin matrix, or perforated glass roving reinforced thermoplastic skin materials (such as a perforated PEI CETEX/Woven glass skin)) using a 3-D deep-drawn article in which the exterior surface of the article has “Class A” finish quality.

In one embodiment, the trim panel is made from a planar layer of honeycomb or other open (greater than 28% open area) structural materials, like tubular core, perforated thermoforming foam or open thermoplastic rigid foam with large skeleton type cell structure, etc., that is sandwiched between two planar layers of open skin materials, like quadraxial fiber glass impregnated with thermosetting or thermoplastic resin matrix. The skin and core materials can include thermosetting or thermoplastic or a material mix referred as hybrid system. An advantage of using thermoplastic core materials is to achieve a larger degree of deformation compared to thermosetting core materials (e.g. like NOMEX honeycombs.)

In another embodiment, a thermoplastic core and a thermosetting quadraxial fiber glass prepreg with a phenol resign matrix may be used. This hybrid material combination can be manufactured with the well known vacuum bag technology in an autoclave or oven or they can be manufactured using a thermoforming machine with a 3-D deep-drawing method, resulting in a cycle time of less than one hour.

In the specific case when thermosetting materials are used, additional heat is provided by the externally heated (male and female) molding tools in order to cure the resin completely. In both cases (thermoplastic and thermosetting or hybrid materials) a cooling down phase follows. In order to accelerate this cooling down process either highly moisturized cold air or cooling liquid in the tools are used.

In an alternative embodiment, a mold on one side and a vacuum bell jar with a diaphragm on the other side can be used to form and compress the complete bundle into the shape of the trim panel. After the required mold release temperature is reached and once the vacuum has been released, the mold can be opened and the finished molded article is removed.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of making a trim panel for an aircraft, comprising the actions of:
a. sandwiching an open structure core layer between a first open structure skin layer and a second open structure skin layer thereby forming a bundle having a top surface, an opposite bottom surface and an outward periphery, at least one of the open structure core layer, the first open structure skin layer and the second open structure skin layer including a material that changes ductility as a result of heat being applied thereto;
b. applying a first impervious diaphragm to the top surface and a second impervious diaphragm to the bottom surface;
c. clamping the first impervious diaphragm, the bundle and the second impervious diaphragm about the periphery, thereby creating an airtight seal about the bundle;
d. subjecting the bundle to a vacuum;
e. heating the bundle to a first predetermined temperature;
f. placing the bundle between a male half of a mold and a female half of a mold, the mold being shaped so as to produce a cast having a shape corresponding to an aircraft trim panel;
g. applying a force to the mold that is sufficient to cause the bundle to take the shape of the cast;
h. cooling the bundle to a second predetermined temperature after the force has been applied to the bundle for a predetermined amount of time, the second predetermined temperature being cool enough to cause the bundle to maintain the shape of the aircraft trim panel; and
i. separating the male half of the mold from the female half of the mold once the bundle has reached the second predetermined temperature and removing the trim panel from the mold.

2. The method of claim 1, wherein the action of applying a force comprises the action of placing the mold and the bundle into a three dimensional deep draw thermoforming machine.

3. The method of claim 1, wherein the open structure core layer comprises a thermoplastic material.

4. The method of claim 1, wherein the open structure core layer comprises a selected one of an open cell honeycomb material, an open cell tubular material and a perforated thermoforming foam material.

5. The method of claim 1, wherein the open structure core layer comprises a thermosetting material.

6. The method of claim 1, wherein the open structure core layer comprises a material that has at least a 28% open area.

7. The method of claim 1, wherein the first open structure skin layer and the second open structure skin layer each comprise a selected one of a quadraxial fiberglass lay-up prepreg material with a resin matrix and a reinforced thermoplastic skin material.

8. The method of claim 1, wherein the first open structure skin layer and a second open structure skin layer each comprise a material that has at least a 28% open area.

9. The method of claim 1, further comprising the actions of:
a. applying a first binder layer between the open structure core layer and the first open structure skin layer; and
b. applying a first binder layer between the open structure core layer and the second open structure skin layer.

10. The method of claim 1, further comprising the actions of:
a. applying a first mold release film between the top surface of the bundle and the first impervious diaphragm; and
b. applying a second mold release film between the bottom surface of the bundle and the second impervious diaphragm.

11. An aircraft trim panel, comprising:
a. a first open structure skin layer;
b. a second open structure skin layer; and
c. an open structure core layer sandwiched between the first open structure skin layer and the second open structure skin layer,
the first open structure skin layer, the second open structure skin layer and the open structure core layer formed into a three dimensional shape corresponding to the aircraft trim panel.

12. The aircraft trim panel of claim 11, wherein the open structure core layer comprises a thermoplastic material.

13. The aircraft trim panel of claim 11, wherein the open structure core layer comprises a selected one of an open cell honeycomb material, an open cell tubular material and a perforated thermoforming foam material.

14. The aircraft trim panel of claim 11, wherein the open structure core layer comprises a thermosetting material.

15. The aircraft trim panel of claim 11, wherein the open structure core layer comprises a material that has at least a 28% open area.

16. The aircraft trim panel of claim 11, wherein the first open structure skin layer and the second open structure skin layer each comprise a selected one of a quadraxial fiberglass lay-up prepreg material with a resin matrix and a reinforced thermoplastic skin material.

17. The aircraft trim panel of claim 11, wherein the first open structure skin layer and a second open structure skin layer each comprise a material that has at least a 28% open area.

18. An aircraft trim panel structure, comprising:
a. a thermoplastic resinated quadraxial fiberglass lay-up prepreg first open structure skin layer having at least a 28% open area;
b. a thermoplastic resinated quadraxial fiberglass lay-up prepreg second open structure skin layer having at least a 28% open area; and
c. an open structure core layer having at least a 28% open area sandwiched between the first open structure skin layer and the second open structure skin layer,
the first open structure skin layer, the second open structure skin layer and the open structure core layer formed into a three dimensional shape corresponding to the aircraft trim panel.

19. The aircraft trim panel structure of claim 18, wherein the open structure core layer comprises a selected one of an open cell honeycomb material, an open cell tubular material and a perforated thermoforming foam material.
